(19) United States
(12) Patent Application Publication
(10) Pub. No.: US 2023/0299319 A1
(43) Pub. Date: Sep. 21, 2023

(54) SOFC WATER SUPPLY SYSTEM AND METHOD OF OPERATION

(71) Applicant: Ceres Intellectual Property Company Limited, Horsham, West Sussex (GB)

(72) Inventors: Hongmin Cao, Weifang, Shandong (CN); Xuesong Shen, Weifang, Shandong (CN); Chunlei Gao, Weifang, Shandong (CN); Tao Yang; Fumei Qian, Weifang, Shandong (CN)

(21) Appl. No.: 17/928,667

(22) PCT Filed: Jun. 29, 2021
(86) PCT No.: PCT/CN2021/103011

§ 371 Date: Nov. 30, 2022

(30) Foreign Application Priority Data
Jun. 30, 2020 (CN) 202010624044.7

(51) Int. Cl. H01M 8/04291; H01M 8/0432; H01M 8/04746; H01M 8/04701

(52) U.S. Cl. CPC H01M 8/04291; H01M 8/0432; H01M 8/04716; H01M 8/04761; H01M 2008/1293

(57) ABSTRACT

The invention discloses an SOFC water supply system, which comprises a first water storage tank, a water pump, a second water storage tank, a condenser and a controller. The first water storage tank is provided with a liquid level sensor, a heating element and a temperature sensor; when the temperature sensor detects that the temperature in the first water storage tank is lower than the working temperature, the controller controls a first valve and a second valve to be closed and controls the heating element to be started. According to the SOFC water supply system, the water storage tank is arranged to be of a split structure, namely the first water storage tank and the second water storage tank, and the first water storage tank is used for participating in supply of reformed water and provided with the heating element; when the temperature sensor detects that the temperature in the first water storage tank is lower than the working temperature, the controller controls the first valve and the second valve to be closed and controls the heating element to be started; in other words, the heating element only needs to heat the water in the first water storage tank, and then supply of the reformed water is maintained, so that the heating time is shortened, the heating effect is improved, and icing of a reformed water system is avoided.

### TECHNICAL FIELD

The present invention relates to the technical field of solid oxide fuel cells, particularly to an SOFC water supply system and its method of operation.

### BACKGROUND ART

When a solid oxide fuel cell (SOFC) uses fuels (methane, alcohols, and the like) other than hydrogen, the gas needs to be reformed before entering a stack. The reforming reaction of the gas requires the involvement of water. At room temperature, water is liquid but once the temperature is lower than 0° C., water will be frozen, affecting the water supply for reforming.

Therefore, how to avoid icing of the reformed water system and maintain the normal supply of water for reforming is a current problem.

### SUMMARY OF THE INVENTION

An object of the present invention is to provide an SOFC water supply system and method which can avoid icing of the reformed water system and maintain the normal supply of water for reforming.

A first aspect of the invention provides an SOFC water supply system, comprising:
a first water storage tank, the first water storage tank being provided with a liquid level sensor, a heating element and a temperature sensor;
a water pump, a first outlet of the first water storage tank being in communication with the water pump, and an outlet of the water pump being used for supply of reformed water;
a second water storage tank, a second outlet of the first water storage tank being in communication with an inlet end of the second water storage tank via a first valve, and an outlet end of the second water storage tank being provided with a second valve;
a condenser, the condenser being in communication with the first water storage tank, and being used for cooling tail gas exiting a stack, and delivering liquid water to the first water storage tank; and
a controller, the controller being in communication connection with the first valve, the second valve, the heating element and the liquid level sensor;
when the temperature sensor detects that the temperature in the first water storage tank is lower than the working temperature, the controller controls the first valve and the second valve to be closed and controls the heating element to be started.

The controller can be provided with a preset value L₀ of the liquid level such that when the value L of the liquid level sensor is equal to or smaller than L₀, the controller controls the first valve to be in an open state, and the second valve to be in a closed state; and when the value L of the liquid level sensor is greater than L₀, the controller controls the first valve and the second valve to be opened to discharge excess water.

The SOFC water supply system can further comprise an SOFC hot box, and the first water storage tank and the second water storage tank are both located on the SOFC hot box.

The SOFC water supply system can further comprise a flow meter in communication with an outlet of the water pump, and an outlet of the flow meter is used for supply of reformed water, wherein the flow of the water pump is adjustable, and the water pump and the flow meter are both in communication with the controller; and the controller controls the flow of the water pump according to the value of the flow meter.

A filter can be connected between the water pump and the flow meter.

A deionizer can be connected between the filter and the flow meter.

The volume of the first water storage tank can be smaller than the volume of the second water storage tank. For example, the volume of the first water storage tank can be one fifth of the volume of the second water storage tank.

The SOFC water supply system proposed by the present invention comprises a first water storage tank, a water pump, a second water storage tank, a condenser, and a controller. The first water storage tank is provided with a liquid level sensor, a heating element, and a temperature sensor. A first outlet of the first water storage tank is in communication with the water pump, and an outlet of the water pump is used for supply of reformed water A second outlet of the first water storage tank is in communication with an inlet end of the second water storage tank via a first valve, and an outlet end of the second water storage tank is provided with a second valve. The condenser is in communication with the first water storage tank and is used for cooling tail gas exiting a stack, and delivering liquid water to the first water storage tank. The controller is in communication connection with the first valve, the second valve, the heating element, and the liquid level sensor. When the temperature sensor detects that the temperature in the first water storage tank is lower than the working temperature, the controller controls the first valve and the second valve to be closed and controls the heating element to be started. According to the foregoing SOFC water supply system, the water storage tank is arranged to be of a split structure, namely a first water storage tank and a second water storage tank. The first water storage tank is used for participating in supply of reformed water and provided with the heating element. When the temperature sensor detects that the temperature in the first water storage tank is lower than the working temperature, the controller controls the first valve and the second valve to be closed and controls the heating element to be started. In other words, the heating element only needs to heat the water in the first water storage tank, and then supply of the reformed water is maintained, so that the heating time is shortened, the heating effect is improved, and icing of a reformed water system is avoided. Therefore, the SOFC water supply system proposed by the present invention can avoid icing of the reformed water system, maintain the normal supply of water for reforming and solve the current problem in the art.

A second aspect of the invention provides a method of operating an SOFC water supply system according to the first aspect, comprising: detecting the temperature in the first water storage tank; determining that the temperature in the first water storage tank is lower than the working temperature; controlling the first valve and the second valve to be closed; and controlling the heating element to be started.

### BRIEF DESCRIPTION OF THE DRAWINGS

The drawings used in the description are briefly described below. The drawings in the description below are just some embodiments of the present invention.

FIG. 1 is a schematic view of an SOFC water supply system.

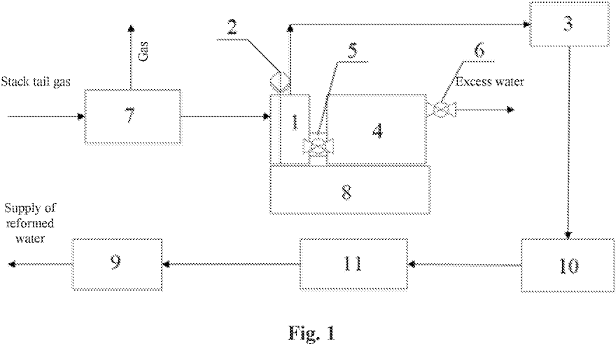

In FIG. 1, the following reference numerals are used:

First water storage tank-1; liquid level sensor-2; water pump-3; second water storage tank-4; first valve-5; second valve-6; condenser-7; SOFC hot box-8; flow meter-9; filter-10; deionizer-11.

### DETAILED DESCRIPTION

The invention provides an SOFC water supply system. The SOFC water supply system can avoid icing of the reformed water system and maintain the normal supply of water for reforming.

Embodiments are described with reference to the drawings. The embodiments shown below do not have any limiting effect on the content of the invention described in the claims. Further, the entire content shown in the following embodiments is not limited to that necessary for a solution of the invention described in the claims.

The SOFC water supply system provided in the detailed description comprises a first water storage tank 1, a water pump 3, a second water storage tank 4, a condenser 7, and a controller. The first water storage tank 1 is provided with a liquid level sensor 2, a heating element, and a temperature sensor. A first outlet of the first water storage tank 1 is in communication with the water pump 3, and an outlet of the water pump 3 is used for supply of reformed water. A second outlet of the first water storage tank 1 is in communication with an inlet end of the second water storage tank 4 via a first valve 5. An outlet end of the second water storage tank 4 is provided with a second valve 6. The condenser 7 is in communication with the first water storage tank 1 and is used for cooling tail gas (i.e. anode/fuel exhaust gas) exiting a stack and delivering liquid water to the first water storage tank 1. The controller is in communication connection with the first valve 5, the second valve 6, the heating element, and the liquid level sensor 2. When the temperature sensor detects that the temperature in the first water storage tank 1 is lower than the working temperature, the controller controls the first valve 5 and the second valve 6 to be closed and controls the heating element to be started.

The water storage tank is arranged to be of a split structure, namely a first water storage tank 1 and a second water storage tank 4. The first water storage tank 1 is used for participating in supply of reformed water and provided with the heating element. When the temperature sensor detects that the temperature in the first water storage tank 1 is lower than the working temperature, the controller controls the first valve 5 and the second valve 6 to be closed and controls the heating element to be started. In other words, the heating element only needs to heat the water in the first water storage tank 1 and the supply of the reformed water can be maintained, so that the heating time is shortened, the heating effect is improved, and icing of a reformed water system is avoided.

Therefore, the SOFC water supply system proposed by the present invention can avoid icing of the reformed water system and maintain the normal supply of water for reforming. FIG. 1 shows details of an embodiment.

During normal operation of the SOFC water supply system, the first valve 5 is open, the second valve 6 is closed, and communication between the first water storage tank 1 and the second water storage tank 4 is maintained to ensure ample supply of reformed water of the SOFC water supply system.

The condenser 7 is a condensate recovery device. Its structure can be a plate type heat exchanger, with tail gas being a hot side, and unheated air or gas being a cold side. Through heat exchange, the tail gas discharged from the stack is cooled and the moisture in the tail gas is condensed. The internal runner structure of the condenser is designed to cause the liquid water to flow towards the first water storage tank 1.

The controller can be provided with a preset value L₀ of the liquid level. When the value L of the liquid level sensor 2 is equal to or smaller than L₀, the controller controls the first valve 5 to be in an open state and the second valve 6 to be in a closed state. This means that the water in the first water storage tank 1 and the water in the second water storage tank 4 are below a reasonable water level. At this time, the SOFC water supply system works normally, and the water pump 3 sucks out a specified amount of water from the first water storage tank 1. After pressurizing, the water is supplied as reformed water.

When the value L of the liquid level sensor 2 is greater than L₀, it means that there is excess water in the first water storage tank 1 and the second water storage tank 4. At this time, the controller controls the first valve 5 and the second valve 6 to be opened so as to discharge excess water.

The SOFC water supply system may further comprise an SOFC hot box 8, and the first water storage tank 1 and the second water storage tank 4 may both be located on the SOFC hot box 8.

There are thermal components such as a stack, a heat exchanger and a burner inside the SOFC hot box 8. Although a thermal insulating material is filled inside the box, some heat still penetrates the thermal insulating layer and is transferred to the external surface. The surface temperature of the SOFC hot box 8 may reach or exceed 50° C. in high temperature zones and is typically approximately room temperature in low temperature zones. The first water storage tank 1 and the second water storage tank 4 can be placed in hotter positions of the external surface of the SOFC hot box 8 to maintain the temperature of the water tanks and prevent icing of the water tanks in winter by using the heat radiated by the SOFC hot box 8. In order to further keep the water flow smooth, a heating function of related pipelines can be added to prevent icing of the water in the pipes.

The SOFC water supply system may further comprise a flow meter 9 in communication with the outlet of the water pump 3. The outlet of the flow meter 9 is used for supply of reformed water. The water pump 3 can be a pump with an adjustable flow, and the water pump 3 and the flow meter 9 are both in communication with the controller. When the reformed water system operates, the controller will control the flow of the water pump 3 according to the value of the flow meter 9.

Further, in the foregoing SOFC water supply system, a filter 10 may be connected between the water pump 3 and the flow meter 9, and a deionizer 11 may be connected between the filter 10 and the flow meter 9. The effects of the filter 10 and the deionizer 11 are to remove the particulate matter and ions in the water and prevent the particulate matter and ions from entering the stack and affecting the life of the stack.

In the SOFC water supply system, the volume of the first water storage tank 1 can be smaller than the volume of the second water storage tank 4, thereby reducing the volume of water heated by the heating element, improving the heating effect, and more quickly bringing the water supply system to a normal operating state.

For example, the volume of the first water storage tank 1 can be one fifth of the volume of the second water storage tank 4. If the SOFC system is started at low temperature for the first time and the temperature sensor detects that the temperature of the first water storage tank 1 is too low and confirms that water in the first water storage tank 1 is frozen, then the controller will control the first valve 5 to be closed and thaw the water in the first water storage tank 1 by means of the heating element. As there is no circulation between the first water storage tank 1 and the second water storage tank 4, less energy is needed to thaw the first water storage tank 1, thereby ensuring that the system is put into operation with the least delay possible.

Various modifications to these embodiments will be apparent within the scope of the invention. The general principle defined herein can be implemented in other embodiments without departing from the spirit or scope of the present invention. Therefore, the present invention will not be limited to the embodiments provided herein but should conform to the widest scope consistent with the principles and novel features disclosed in the claims.

1. An SOFC water supply system, comprising:
a first water storage tank (1) provided with a liquid level sensor (2), a heating element, and a temperature sensor;
a water pump (3), a first outlet of the first water storage tank (1) being in communication with the water pump (3), and an outlet of the water pump (3) for supply of reformed water;
a second water storage tank (4), a second outlet of the first water storage tank (1) being in communication with an inlet end of the second water storage tank (4) via a first valve (5), and an outlet end of the second water storage tank (4) being provided with a second valve (6);
a condenser (7) in communication with the first water storage tank (1) for cooling tail gas exiting a stack and delivering liquid water to the first water storage tank (1); and
a controller in communication with the first valve (5), the second valve (6), the heating element, and the liquid level sensor (2);
wherein when the temperature sensor detects that the temperature in the first water storage tank (1) is lower than the working temperature, the controller is operable to control the first valve (5) and the second valve (6) to be closed and to control the heating element to be started.

2. The SOFC water supply system according to claim 1, wherein the controller is provided with a preset value L₀ of the liquid level and configured such that:
when the value L of the liquid level sensor (2) is equal to or smaller than L₀, the controller is operable to control the first valve (5) to be in an open state, and the second valve (6) to be in a closed state; and
when the value L of the liquid level sensor (2) is greater than Lₐ, the controller is operable to control the first valve (5) and the second valve (6) to be opened to discharge excess water.

3. The SOFC water supply system according to claim 1, further comprising an SOFC hot box (8), and the first water storage tank (1) and the second water storage tank (4) are both located on the SOFC hot box (8).

4. The SOFC water supply system according to claim 1, further comprising a flow meter (9) in communication with an outlet of the water pump (3), wherein an outlet of the flow meter (9) is configured for supply of reformed water;
wherein the flow of the water pump (3) is adjustable, and the water pump (3) and the flow meter (9) are both in communication with the controller; and
the controller is operable to control the flow of the water pump (3) according to the value of the flow meter (9).

5. The SOFC water supply system according to claim 4, wherein a filter (10) is connected between the water pump (3) and the flow meter (9).

6. The SOFC water supply system according to claim 5, wherein a deionizer (11) is connected between the filter (10) and the flow meter (9).

7. The SOFC water supply system according to claim 1, wherein the volume of the first water storage tank (1) is smaller than the volume of the second water storage tank (4).

8. The SOFC water supply system according to claim 7, wherein the volume of the first water storage tank (1) is one fifth of the volume of the second water storage tank (4).

9. A method of operating an SOFC water supply system according to claim 1, comprising:
detecting the temperature in the first water storage tank;
determining that the temperature in the first water storage tank (1) is lower than the working temperature;
controlling the first valve (5) and the second valve (6) to be closed; and
controlling the heating element to be started.

10. The method according to claim 9, wherein:
when the value L of the liquid level sensor (2) is equal to or smaller than a preset value L₀ of the liquid level, controlling the first valve (5) to be in an open state, and the second valve (6) to be in a closed state; and
when the value L of the liquid level sensor (2) is greater than L₀, controlling the first valve (5) and the second valve (6) to be opened to discharge excess water.

11. The method according to claim 9, wherein the system further comprises a flow meter (9) in communication with an outlet of the water pump (3), wherein an outlet of the flow meter (9) is configured for supply of reformed water;
the method further comprising controlling the flow of the water pump (3) according to the value of the flow meter (9).
